(19) United States
(12) Patent Application Publication
(10) Pub. No.: US 2006/0200463 A1
(43) Pub. Date: Sep. 7, 2006

(54) Determining a presentation rule in response to detecting multiple users

(75) Inventors: Richard Dean Dettinger, Rochester, MN (US); Daniel Paul Kolz, Rochester, MN (US); Frederick Allyn Kulack, Rochester, MN (US); Kevin Glynn Paterson, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/071,089

(22) Filed: Mar. 3, 2005

(51) Int. Cl. G06F 17/30

(52) U.S. Cl. 707/6

(57) ABSTRACT

A method, apparatus, system, and signal-bearing medium that, in an embodiment, detect a first user, detect a second user, determine a presentation rule based on the detection of the first and second user, and send the presentation rule to an application. The presentation rule instructs the application to modify data presented by the application. In an embodiment, the presentation rule contains an action that the application is to take. In another embodiment, the presentation rule includes categories of the users, and the application determines the action to take to modify the data in response to the categories. In various embodiments, the rule may instruct the application to remove information from the presented data, exclude information from a directory from the presented data, remove a window from the presented data, remove a portion of the window from the presented data, or restrict a user interface element. The data presented by the application is capable of being received by the first user and the second user. Detecting the first user may include receiving an identification of the first user and a password for the first user. Detecting the second user may include detecting physical presence of the second user, receiving an identification of the second user, receiving an identification of the second user and a password for the second user, or receiving an identification of a group. In this way, users may be presented data that is appropriate for those present while data that is inappropriate may be excluded from presentation.

### FIELD

An embodiment of the invention generally relates to computers. In particular, an embodiment of the invention generally relates to determining a data presentation rule in response to detecting the presence of multiple users.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

In the past, users only saw their own computer or computer terminal, were rarely in the presence of someone else's computer, and tended to use computers for only a single job, task, or application at a time. But today, as computers become more and more common and are used in more and more environments, people are increasingly in the presence of a computer or a computer interface device belonging to someone else. Some of the data displayed or presented by the computer may be appropriate for the non-owning or non-logged in user to see while other data is inappropriate. Further, computers are now multi-tasking with multiple applications executing simultaneously, any one of which might present unanticipated data at an unpredictable moment, which may be inappropriate for viewing by someone who happens to be nearby. These multiple applications may be of a wide variety of types, such as wizards, reminders, or agents, and the user may have limited memory awareness of their existence, until they unexpectedly start displaying information.

For example, a computer may be present in an examining room that a doctor uses to examine patients and diagnose diseases. Many people and combinations of people may have access to the examining room that contains the computer, including a variety of different doctors, patients, nurses, insurance coordinators, and custodians. The doctor may use the same computer to examine patient records associated with a variety of patients, to read the drug interactions and adverse effects for a variety of medications, to access the clinic's financial records, and to send e-mail to colleagues, nurses, pharmaceutical representatives, and insurance companies. The doctor may want a particular patient to see some of the data displayed on the computer, for example, the patient's own treatment records or potential adverse effects for the medication that the doctor is prescribing for the patient. But, the doctor does not want the patient to see the confidential treatment records for other patients, the clinic's financial records, or e-mail correspondence that the doctor sends to others. Further, viewing all patient records might be appropriate for a nurse in the examining room, but viewing the clinic's financial records is inappropriate. Even further, if the doctor, two patients (a parent and a minor child), and the nurse are all present in the examining room at the same time, then the data appropriate to be displayed at the computer might be the intersection of the data appropriate for each individually. For example, the parent wants to see the minor child's records, but the child need not see the parent's records.

As another example, companies increasingly work collaboratively with others, such as a joint development relationship with a contractor, a supplier, or a vendor. These companies need to share some of the data that is related to the joint development effort while keeping other data confidential that is unrelated to the joint development effort. The owner of the confidential data does not want to disclose it, and the non-owner does not want to be contaminated with the other's confidential data. Yet, to accomplish the joint development project, representatives of both companies may need to work side-by-side and view the same data, design documentation, or code on the same computer at the same time.

In an attempt to address these problems, current systems segregate their data on different computers in different rooms and use different log ins, different profiles, different security access levels, or different configuration settings for multiple users. But, these current systems rely on the individual users to remember to log off or close applications when they leave the vicinity of the computer, to observe who else is present and in a physical position capable of viewing or accessing the displayed or presented data, and to use judgment as to what data to access or what application to execute based on who is present. Relying on individuals to be ever-vigilant in observing who else is present at a time when they are focused on solving difficult problems is unrealistic and error-prone, especially since one person using a computer may have little control over whether and at what time others stop by to ask questions or for impromptu meetings. Further, current computers include a wide variety of applications, agents, reminders, wizards, and tasks, which may be very difficult for the user to locate and turn off or temporarily disable.

Without a better technique for customizing presentation of data for the users who are present, users will continue to struggle with presenting appropriate data for the audience who is present.

### SUMMARY

A method, apparatus, system, and signal-bearing medium are provided that, in an embodiment, detect a first user, detect a second user, determine a presentation rule based on the detection of the first and second user, and send the presentation rule to an application. The presentation rule instructs the application to modify data presented by the application. In an embodiment, the presentation rule contains an action that the application is to take. In another embodiment, the presentation rule includes categories of the users, and the application determines the action to take to modify the data in response to the categories. In various embodiments, the rule may instruct the application to remove information from the presented data, exclude information from a directory from the presented data, remove a window from the presented data, remove a portion of the window from the presented data, or restrict a user interface element. The data presented by the application is capable of being received by the first user and the second user. Detecting the first user may include receiving an identification of the first user and a password for the first user. Detecting the second user may include detecting physical presence of the second user, receiving an identification of the second user, receiving an identification of the second user and a password for the second user, or receiving an identification of a group. In this way, users may be presented data that is appropriate for those present while data that is inappropriate may be excluded from presentation.

### BRIEF DESCRIPTION OF THE DRAWING

Various embodiments of the present invention are hereinafter described in conjunction with the appended drawings:

FIG. 1 depicts a block diagram of an example system for implementing an embodiment of the invention.

FIG. 2 depicts a block diagram of an example data structure for user data, according to an embodiment of the invention.

FIG. 3 depicts an example flowchart of processing the presence of multiple users, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

In an embodiment, an access controller associated with a computer detects multiple users, determines a presentation rule based on detecting the presence of the multiple users, and sends the presentation rule to an application. The presentation rule instructs the application to modify data presented by the application, which in various embodiments may include instructing the application to remove information from the presented data, instructing the application to exclude information from a directory from the presented data, instructing the application to remove a window from the presented data, or instructing the application to remove a portion of the window from the presented data. The data presented by the application is capable of being received, viewed, or accessed by the multiple users. The information removed is appropriate for receipt by at least one user, but inappropriate for receipt by the other users. Detecting the presence of a user may include detecting physical presence, receiving an identification of the user, receiving an identification of the user and a password for the user, or receiving an identification of a group to which the user belongs. Thus, as used herein, a user may be a person logged into the computer or application, or may be merely physically present or otherwise capable of viewing, hearing, sensing, receiving, or accessing data, but not necessarily logged into the computer or any application. In this way, users may be presented data that is appropriate for those present while data that is inappropriate may be excluded from presentation.

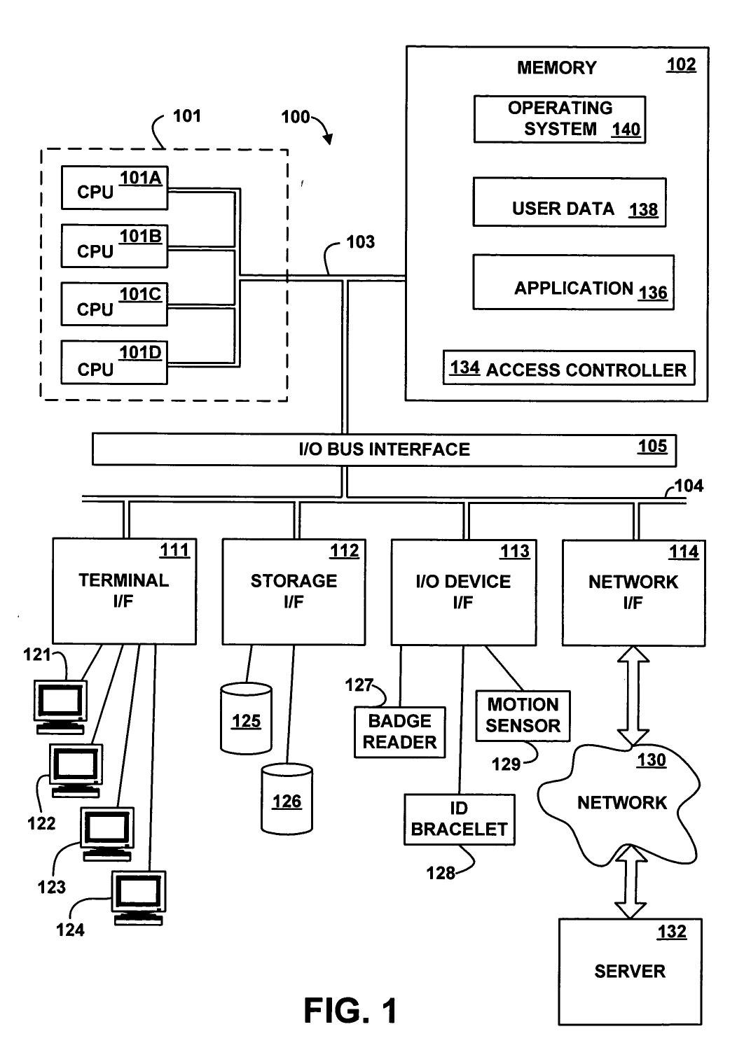

Referring to the Drawing, wherein like numbers denote like parts throughout the several views, FIG. 1 depicts a high-level block diagram representation of a computer system 100 connected to a server computer 132 via a network 130, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as a processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes an access controller 134, an application 136, user data 138, and an operating system 140. Although the access controller 134, the application 136, the user data 138, and the operating system 140 are illustrated as being contained within the memory 102 in the computer system 100, in other embodiments some or all of them may be on different computer systems, e.g., the server 132, and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the access controller 134, the application 136, the user data 138, and the operating system 140 are illustrated as being contained within the main memory 102, these elements are not necessarily all completely contained in the same storage device at the same time.

The operating system 140 controls the allocation and usage of hardware resources of the computer system 100 among various applications, processes, or threads, such as processing time of the processor 101, the memory 102, disk space, and peripheral devices. The operating system 140 is typically the foundation on which applications are built and controls the primary operations of the computer 100. The operating system 140 may be implemented using the iSOS operating system available from International Business Machines Corporation, but in other embodiments the operating system 140 may be Linux, AIX, UNIX, Microsoft Windows, or any appropriate operating system.

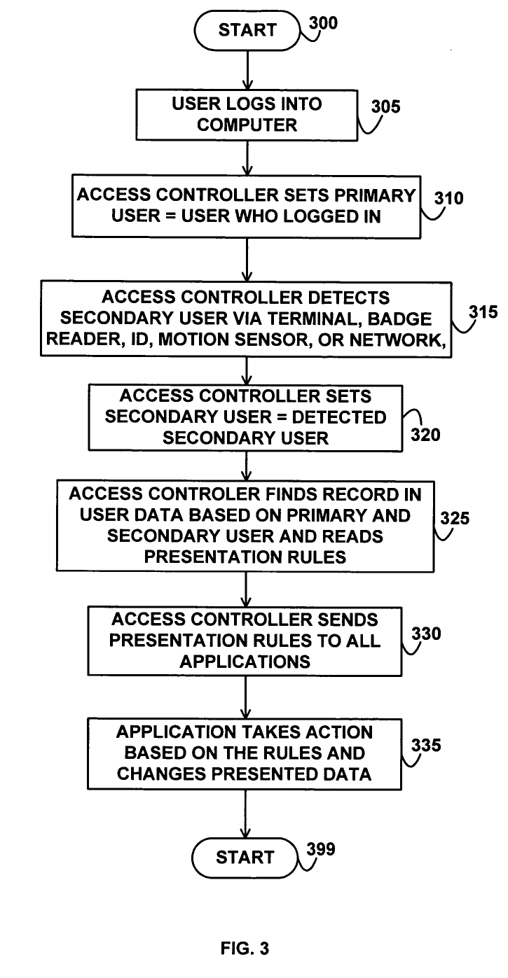

The access controller 134 detects users and communicates presentation rules in response to the detection to the applications 136. Although the access controller 134 is illustrated as being separate from the operating system 140 and the application 136, in other embodiments the access controller 134 may be packaged with the operating system 140 and/or the application 136. In an embodiment, the access controller 134 includes instructions capable of executing on the processor 101 or statements capable of being interpreted by instructions executing on the processor 101 to perform the functions as further described below with reference to FIG. 3. In another embodiment, the access controller 134 may be implemented in microcode. In another embodiment, the access controller 134 may be implemented in hardware via logic gates and/or other appropriate hardware techniques.

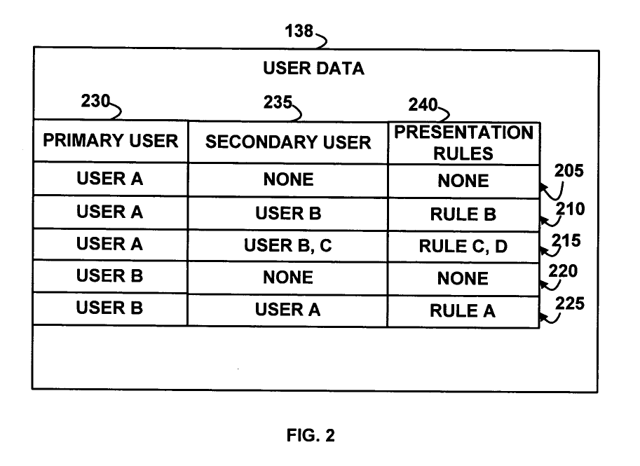

The application 136 presents data that may be received, viewed, heard, sensed, or otherwise detected by users. In various embodiments, the application 136 may be the operating system 140, a calendar application, an instant messaging client, an email application, a browser, a database management application, an integrated development environment, or any other appropriate application. The user data 138 identifies users and presentation rules that specify how data is to be presented. The user data 138 is further described below with reference to FIG. 2.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125 and 126, which are typically rotating magnetic disk drive storage devices, although they could alternatively be other devices, including arrays of disk drives configured to appear as a single large storage device to a host. The contents of the main memory 102 may be stored to and retrieved from the direct access storage devices 125 and 126.

The I/O and other device interface 113 provides an interface to any of various other input/output devices or devices of other types. Three such devices, the badge reader 127, the ID (identifier) bracelet 128, and the motion sensor 129, are shown in the exemplary embodiment of FIG. 1, but in other embodiment many other such devices may exist, which may be of differing types. The devices, such as the badge reader 127, the ID bracelet 128, and/or the motion sensor 129 may uniquely identify users, may identify classes of users, or may simply detect that a user (someone or something) is physically present in the vicinity of the device. The network interface 114 provides one or more communications paths from the computer system 100 to other digital devices and computer systems; such paths may include, e.g., one or more networks 130.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3× specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.111B wireless network. In still another embodiment, the network 130 may be any suitable network or combination of networks. Although one network 130 is shown, in other embodiments any number (including zero) of networks (of the same or different types) may be present.

It should be understood that FIG. 1 is intended to depict the representative major components of the computer system 100 at a high level, that individual components may have greater complexity that represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive (e.g., the DASD 125 and 126), CD-RW, DVD-RW, DVD+RW, DVD-RAM, or diskette; or

(3) information conveyed by a communications medium, such as through a computer or a telephone network, e.g., the network 130, including wireless communications.

Such signal-bearing media, when carrying machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of an example data structure for the user data 138, according to an embodiment of the invention. The user data 138 includes records 205, 210, 215, 220, and 225, but in other embodiments any number of records with any appropriate data may be present. Each of the records 205, 210, 215, 220, and 225 includes a primary user 230, a secondary user 235, and presentation rules 240.

The primary user 230 indicates the user whom the access controller 134 detects before the access controller 134 detects the secondary user 235. In various embodiments, the primary user 230 may be a user who is logged in to the computer 100 or the application 136, who has an account and a password for the computer 100, who has a user profile for the computer 100, or may simply be a person whom the access controller 134 detects via the terminals 121, 122, 123, or 124, badge reader 127, the ID bracelet 128, the motion sensor 129, or the network 130. The secondary user 235 indicates a user who is physically present in the area of the computer 100, as detected after the primary user 230 by the access controller 134 via the terminals 121, 122, 123, or 124, the badge reader 127, the ID bracelet 128, the motion sensor 129, or the network 130.

Further, any combination of the terminals 121, 122, 123, 124, the badge reader 127, the ID bracelet 128, the motion sensor 129, and the network 130 may be used to detect the primary user 230 and the secondary user 235. For example, in an embodiment, the primary user 230 is the first person detected at a kiosk (e.g., an ATM), either via the user entering a password via the terminal 121 or via the motion sensor 129. The secondary user 235 is any subsequent person or persons detected nearby via the motion sensor 129 who might be in a position that permits viewing the personal financial data of the primary user 230 or keystrokes that the primary user 230 employs to enter the password. In another example, the primary user 230 is a doctor logged into a computer in an examining room, and the secondary users 235 may be a patient and a nurse detected via the ID bracelet 128. In another example, the primary user 230 is a user of a computer detected via the terminal 121, and the secondary user 235 is a help desk technician who is accessing the user's computer remotely via the network 130, in order to assist the user with a technical problem.

In an embodiment, the primary user 230 and/or the secondary user 235 may uniquely identify individuals. In another embodiment, the primary user 230 and/or the secondary user 235 may identify classes or groups of users, such as a visitor class, a guest class, a client class, a patient class, a doctor class, a class of users with a certain security level, or any other appropriate class. In another embodiment, the primary user 230 and/or the secondary user 235 may both uniquely identify a user and the class to which the user belongs.

The presentation rules 240 include categories, actions, profiles, security levels, or other data that the access controller 134 passes to the application 136 in response to the detection of the associated primary user 230 and secondary user 235. The presentation rules 240 instruct the application 136 to modify data presented by the application 136.

In an embodiment, the presentation rules 240 may include an action that the application 136 is to take to modify presented data, such as explicit restrictions of the presented data to certain directories, libraries, files, or access paths, restrictions of the presented data based on ownership of the data, or restrictions based on meta data. Examples of meta data include the subject of an email, the sender of the email, or the patient associated with a medical record. The action may also identify restrictions on user interface elements, such as instructions to change a GUI component to read only, lock a scroll bar, disable the keyboard, mouse, or other input device, stop speech-to-text recognition, or encrypt text display. Thus, the rules 240 give the application 136 an explicit action, and the application 136 does not have a choice as to the action or restrictions to implement in response to the rules 240.

In another embodiment, the presentation rule 240 includes a category or categories of the users, and the application 136 chooses the action to take to modify the data in response to the category. In various embodiments, the category may include identifications of the primary user 230 and the secondary user 235, user types for the primary user 230 and the secondary user 235, profiles for the primary user 230 and the secondary user 235, and/or authorizations or security levels associated with the primary user 230 and the secondary user 235. In response to the categories, the application 136 determines the presented data that is appropriate for viewing by the detected users and modifies information in the presented data. The application 136 may choose any or all of the actions restrictions previously described above.

In various embodiments, the presentation rules 240 may be either the same or different for a particular user depending on whether the user is the primary user 230 or the secondary user 235. For example, in an embodiment, the presentation rules 240 for a user A and a user B may be the same regardless of which of user A and user B is the primary user 230; thus which user is detected first makes no difference to the presentation rules 240. But, in another embodiment, the presentation rules 240 may be different when user A is the primary user 230 and user B is the secondary user 235 from the case when user B is the primary user 230 and user A is the secondary user 235; thus which user is detected first changes the presentation rules 240.

In an embodiment, the presentation rules 240 may be preloaded into the user data 138 for every possible primary user 230 and secondary user 235. In another embodiment, the presentation rules 240 may be calculated based on the primary user 230 and the secondary user 235 that the access controller 134 detects. For example, if the primary user 230 and the secondary user 235 indicate classes having certain security clearances or profiles, the access controller 134 may perform the intersection of the data that the primary user 230 and secondary user 235 are authorized to access in order to determine the presentation rules 240.

As another example, if the secondary user 235 indicates multiple users, e.g., the record 215, the access controller 134 may calculate the presentation rules 240 for the multiple users based on the intersection, union, addition, or any other function of the presentation rules for the users individually. Thus, in an embodiment, the inclusion of multiple users may change the presentation rules 240, as indicated in the record 215.

FIG. 3 depicts an example flowchart of processing for the access controller 134, according to an embodiment of the invention. Control begins at block 300. Control then continues to block 305 where a first user logs into the computer 100, logs into the application 136, or is otherwise detected by the access controller 134 via the terminals 121, 122, 123, or 124, the badge reader 127, the ID bracelet 128, the motion sensor 129, or the network 130. In an embodiment, the access controller 134 receives an identification of the first user and a password for the first user. Control then continues to block 310 where the access controller 134 sets the user detected at block 305 to be the primary user.

Control then continues to block 315 where the access controller 134 detects a second user via one of the terminals 121, 122, 123, or 124, the badge reader 127, the ID bracelet 128, the motion sensor 129, or the network 130. In various embodiments, the access controller 134 detecting the second user includes detecting mere physical presence of the second user, receiving an identification of the second user, or receiving an identification of the second user and a password for the second user.

Control then continues to block 320 where the access controller 134 sets the user detected at block 315 to be the secondary user. Control then continues to block 325 where the access controller 134 determines the presentation rule 240 based on the detection of the presence of the primary user 230 and the secondary user 235. In an embodiment, the access controller 134 determines the presentation rule 240 by finding a record in the user data 138, for example the record 205, 210, 215, 220, or 225 that is associated with the detected primary user and the detected secondary user via the primary user field 230 and the secondary user field 235. In another embodiment, the access controller 138 determines the presentation rule 240 by performing a calculation based on the primary user 230 and the secondary user 235.

Control then continues to block 330 where the access controller 134 sends the found presentation rule 240 to all applications 136 present at the computer 100. The applications 136 may be currently active or present but not currently executing. In various embodiments, the access controller 134 may send the found presentation rule 240 to all applications, or selected applications, at the server 132. The presentation rule instructs the application 136 to modify data presented by the application or remove information from the data presented, where the information to be removed is appropriate for receipt by the primary user but is inappropriate for receipt by the secondary user. In various embodiments, the information to be removed may be confidential, private information, or information owned by the primary user that is inappropriate for disclosure to the secondary user.

Control then continues to block 335 where the application 136 takes action based on the received presentation rule 240 and modifies or changes data that the application 136 presents in response to the presentation rule 240. In various embodiments, the presented data may be displayed on a display screen of the terminals 121, 122, 123, or 124, may be played via a speaker, printed on a printer, projected onto a screen, sent via a fax or email, or presented via any other appropriate type of output device. The presented data is capable of being accessed, viewed, heard, detected, or received by both the primary user and the secondary user. In various embodiments, the application 136 may modify the data by restricting certain files, records, libraries, directories, or access paths from the presented data, by removing a window from the display of the presented data, or by removing a portion of data from a window. In various embodiments, a portion of data may include any data or any user interface element. Control then continues to block 399 where the logic of FIG. 3 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
detecting a first user;
detecting a second user;
determining a presentation rule based on the first user and the second user; and
modifying data presented by an application in accordance with the presentation rule.

2. The method of claim 1, wherein the detecting the first user further comprises:
receiving an identification of the first user and a password for the first user.

3. The method of claim 1, wherein the detecting the second user further comprises:
detecting physical presence of the second user.

4. The method of claim 1, wherein the detecting the second user further comprises
receiving an identification of the second user.

5. The method of claim 1, wherein the detecting the second user further comprises:
receiving an identification of the second user and a password for the second user.

6. The method of claim 1, wherein the presentation rule identifies an action that the application is to take to modify the data presented.

7. The method of claim 1, wherein the presentation rule comprises categories of the first user and the second user and the categories instruct the application to choose an action to modify the data.

8. A signal-bearing medium encoded with instructions, wherein the instructions when executed comprise:
detecting a first user;
detecting a second user;
determining a presentation rule based on the first user and the second user; and
sending the presentation rule to an application, wherein the presentation rule instructs the application to remove information from data presented by the application.

9. The signal-bearing medium of claim 8, wherein the detecting the first user further comprises:
receiving an identification of the first user and a password for the first user.

10. The signal-bearing medium of claim 8, wherein the detecting the second user further comprises:
detecting physical presence of the second user.

11. The signal-bearing medium of claim 8, wherein the detecting the second user further comprises
receiving an identification of the second user.

12. The signal-bearing medium of claim 8, wherein the detecting the second user further comprises:
receiving an identification of the second user and a password for the second user.

13. The signal-bearing medium of claim 8, wherein the presentation rule further instructs the application to exclude a directory from the presented data.

14. The signal-bearing medium of claim 8, wherein the presentation rule further instructs the application to remove a window from the presented data.

15. A method for configuring a computer, comprising:
configuring the computer to detect a first user;
configuring the computer to detect a second user;
configuring the computer to determine a presentation rule based on the first user and the second user; and
configuring the computer to send the presentation rule to an application, wherein the presentation rule instructs the application to modify data presented by the application.

16. The method of claim 15, wherein the configuring the computer to determine the presentation rule further comprises:
configuring the computer to change the presentation rule in response to detecting a third user.

17. The method of claim 15, wherein the presentation rule further instructs the application to modify a user interface element.

18. The method of claim 15, wherein the presentation rule further instructs the application to exclude a directory from the presented data.

19. The method of claim 15, wherein the presentation rule further instructs the application to remove a window from the presented data.

20. The method of claim 15, wherein the presentation rule further instructs the application to remove a portion of a window from the presented data.
